(19) United States
(12) Patent Application Publication
(10) Pub. No.: US 2016/0048366 A1
(43) Pub. Date: Feb. 18, 2016

(54) Video Streaming System and Method for a Wearable Display

(71) Applicants: David John Cowin, Winter Park, FL (US); Joshua Donlan, Oviedo, FL (US)

(72) Inventors: David John Cowin, Winter Park, FL (US); Joshua Donlan, Oviedo, FL (US)

(21) Appl. No.: 14/827,138

(22) Filed: Aug. 14, 2015

Related U.S. Application Data
(60) Provisional application No. 62/037,322, filed on Aug. 14, 2014.

(51) Int. Cl. G06F 3/14; H04W 12/08; H04W 12/06; G02B 27/01; G06F 1/16

(52) U.S. Cl. CPC G06F 3/1423; G02B 27/017; G06F 1/163; H04W 12/06; H04W 12/08

(57) ABSTRACT

A video display system includes a secure integrated wireless network employed by a receiver and player having authorization to connect to the network. The receiver accepts analog or digital video signals through a single video input and automatically transcodes the video signal into a video stream for transmitting over an integrated secure network to the player. A wireless integrated display device authorized to connect to the network is operable with the receiver. The player is configured to automatically find and connect to the secured network and be paired with the receiver for connecting to a real time stream hosted on the receiver for playing the stream on the integrated display.

### FIELD OF INVENTION

The present disclosure generally relates to data streaming and in particular to a data streaming system that accepts a video signal and wirelessly transmits the signal to a video playback device.

### BACKGROUND

Often while performing a task, one will be required to look away from their immediate field of view (i.e. the task area) to obtain certain information from a video monitor or other device. For example, an operating surgeon will often have to look away from a patient and/or the operating environment to view a video monitor displaying information pertaining to the patient or the surgery, such as vital signs, a surgical plan, or an image from a surgical endoscope operable with a camera. Having to look away from the environment and task at hand can be dangerous or distracting, especially when the task is an activity such as surgery involving the delicate manipulation of surgical instruments and/or a patient's vital organs.

Further, due to the restricted view in certain environments, such as an operating room, it is difficult for a surgeon to appreciate the perspective of the exact field of view of a trainee or other colleague performing a surgical procedure, thereby complicating the process of providing essential feedback or input on certain surgical techniques. For example, field of view concerns are especially prevalent in the highly complex area of cardiothoracic training, where a major challenge is creating an environment in which one surgeon can provide direct visual feedback to another surgeon or third-party observer while actively conducting operations.

Attempts at overcoming these problems have proven unsuccessful. For example, wearable computers having both an optical head-mounted display and a camera have been used to transmit surgical techniques in real time. By way of example, an Internet-connected headset allows a trainee's eye view from the operating room to be transmitted, in real time, to instructors or other observers. As a result, by seeing what the trainees are seeing, the instructors can give better feedback to their students via the device.

Existing technology also suffers from several undesirable limitations. For example, existing means for the transmission of patient data from a device is typically unsecure and capable of interception by an unintended third party, thereby making existing technology noncompliant with existing patient privacy laws and regulations. Further, many devices suffer from undesirable hardware and software incompatibility concerns. Existing technologies are also incapable of allowing the wearer of the device to effectively, easily, and securely communicate with multiple display devices. The embodiments disclosed herein are aimed at fulfilling these and other needs in the art.

### SUMMARY

Unlike known video streaming systems, one advantage of the embodiments according to the teachings of the present disclosure includes providing signal transmission to a display device regardless of the source of the original signal, thereby eliminating hardware and software incompatibility concerns. The embodiments described herein thus operate generically with regard to the video input and without a need for custom configurations.

Another advantage of the embodiments of the system of the present disclosure includes providing an image on a display device within the direct field of view of a user of the system, thereby eliminating the need to look away from the task environment to obtain information pertaining to the task at hand.

Yet another advantage of the embodiments of the system of the present disclosure includes providing a first device capable of accepting any video signal and converting the video to a video stream that may be served by the first device via an integrated wireless network to one or more display devices authorized to receive the video stream from the first device.

A video display system according to the teachings of the present disclosure may include a secure integrated wireless network employed by a receiver and a player having authorization to connect to the network. In one embodiment, the receiver or “capture appliance” accepts analog or digital video signals from a video capture device or other device via industry standard ports, such as for example DVI or BNC, and automatically transcodes the video signal in real time into raw data. The receiver then serves the raw byte stream to a display device (or “player”/“playback appliance”) over a secure network, such as for example over one or more secure point-to-point data sockets. The display device then assembles the raw byte data into viewable video in near real-time to be viewed on an integrated display operable with the display device.

One embodiment includes a wireless integrated display device authorized to connect to the network and operable with the receiver. The display device is configured to automatically find and connect to the secured network and be paired with the receiver for connecting to a video stream hosted on the receiver for playing the stream on the integrated display.

### BRIEF DESCRIPTION OF DRAWINGS

Embodiments are described by way of example with reference to the accompanying drawings in which:

FIG. 1A is a block diagram of a system according to the teachings of the present disclosure

FIG. 1B is a block diagram of a system according to the teachings of the present disclosure having a receiver accepting video signals through a video input and transmitting transcoded video signals into a video stream over an integrated secure network to one or more players;

FIG. 2 is a block diagram of a system according to the teachings of the present disclosure;

FIG. 3 is a block diagram illustrating functional components of the receiver of FIGS. 1 and 2;

FIG. 4A illustrates one use of hands-free operation using the wearable display device in combination with the system and teachings of the present disclosure; and

FIG. 4B depicts an embodiment of a display device utilized in combination with the system and teachings of the present disclosure.

### DETAILED DESCRIPTION OF EMBODIMENTS

The embodiments of the system and methods of the present disclosure will now be described more fully hereinafter with reference to the accompanying drawings, in which embodiments are shown by way of illustration and example. The embodiments disclosed may, however, be embodied in many forms and should not be construed as limited to the embodiments set forth herein. Rather, these embodiments are provided so that this disclosure will be thorough and complete, and will fully convey the scope of the embodiments to those skilled in the art. Like numerals refer to like elements.

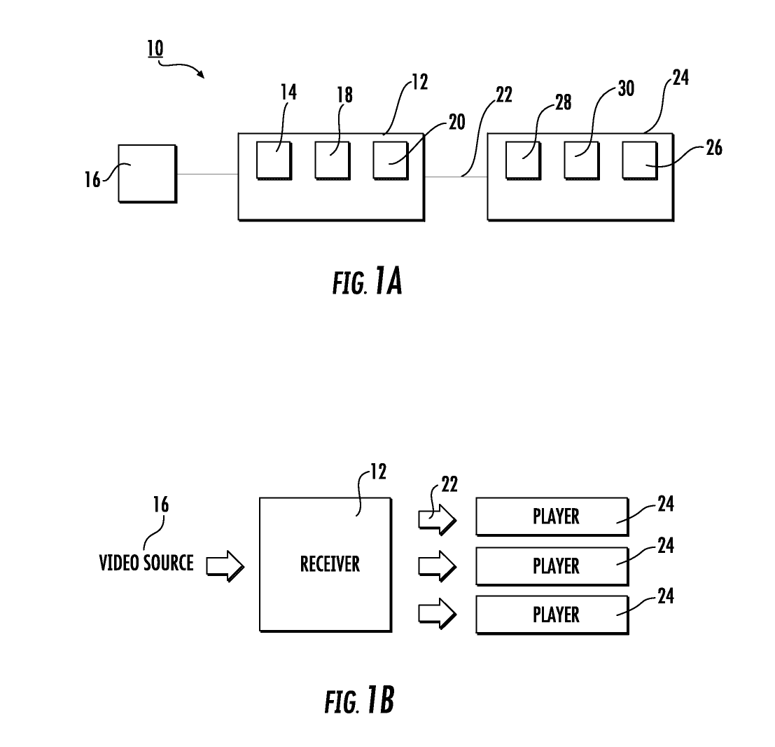

Initially with reference to FIG. 1A, an embodiment of the present disclosure includes a system 10 for displaying a video. The system 10 comprises a first device, or receiver 12, having a video signal input 14 for receiving a video signal and a processing unit 18 for processing the video signal. The processing unit 18 provides video data corresponding to the video signal. The first device 12 further comprises a network device 20 for providing a secure wireless network 22.

With continued reference to FIG. 1A, the system 10 further comprises a display device 24 having an integrated display 26, the display device 24 in communication with the secure wireless network 22. The display device 24 has a video data receiving unit 28 for receiving the video data from the first device 12 via the secure wireless network 22. In one embodiment of the system 10, the display device 24 further comprises an interpreting unit 30 for interpreting the video data and providing an image corresponding to the video data. The image may then be displayed on the integrated display 26.

With reference to FIG. 1B, one embodiment of the system 10 includes a receiver 12. The receiver 12 may provide a base unit that accepts any analog or digital video signal from 640×480 to 1900×1200 resolution through industry standard ports, such as a single digital video interface (DVI) video input or BNC. The receiver 12 may also be configured to receive any other type of video signal, including but not limited to any high resolution video format, such as 4 k or three-dimensional video formats. The digital interface, or other video-receiving port, is used to connect a video source 16, such as a display controller or camera, to the receiver 12. In one embodiment, the video signal may be wirelessly received by the receiver 12. The receiver 12 also provides an integrated secure wireless network 22 for subsequent transmission of a video signal to associated video display devices 24.

The receiver 12 automatically transcodes the video signal into a video stream, which is transmitted over the integrated secure network 22 to one or more video display devices 24. The integrated wireless network 22 is secured using hardware and/or software restrictions, thereby preventing unauthorized devices from connecting to the receiver 12 and playing the stream. By way of example, the receiver 12 may support over 200 simultaneously pre-authorized wireless display devices 24, or any other preferred number of display devices 24.

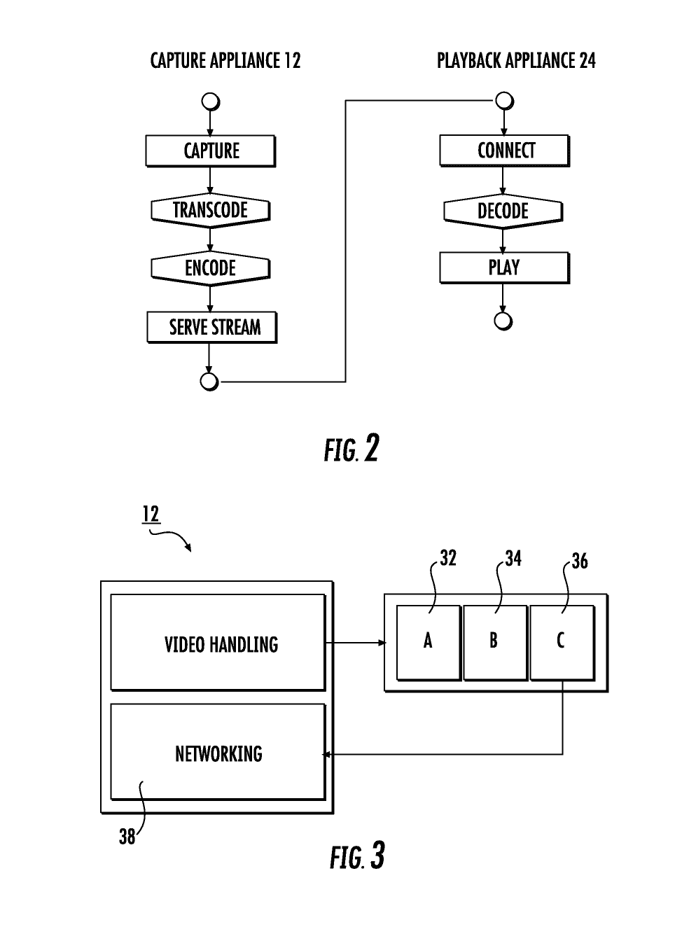

In one embodiment, and with reference to FIG. 2, the receiver 12 or “capture appliance” accepts, or captures, an incoming video signal and transcodes the video in real-time into raw data. The transcoded video data is then encoded into raw byte information. The byte information is then available upon request to be served to the display device 24, or “playback appliance”. In one embodiment, the byte information may be served over a secure socket connection between the receiver 12 and a display device 24 or player. Any other secure transmission means is also considered to be within the scope of the present disclosure.

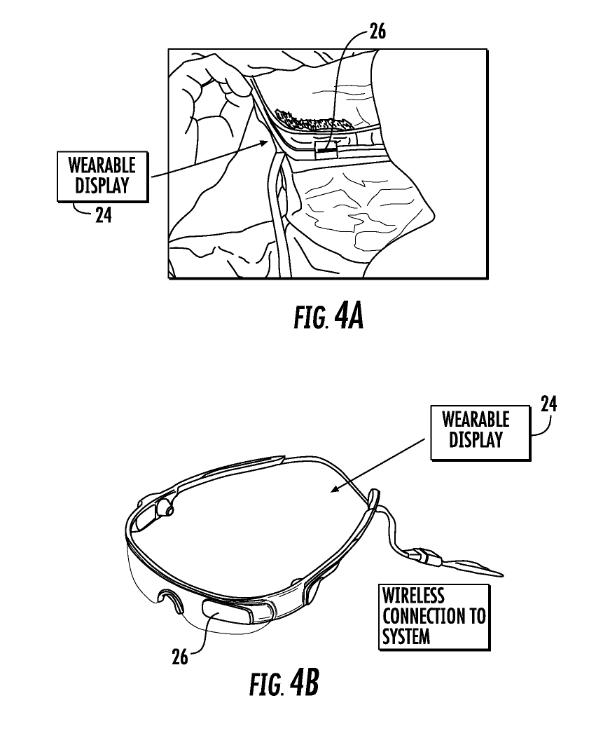

With reference again to FIGS. 1A and 1B, an embodiment of a display device 24, or player, comprises an integrated display 26 operable with the secure network 22 hosted by the receiver 12. In one embodiment, the display device 24 is a wearable display device, such as that depicted in FIGS. 4A and 4B. The wearable display may comprise any suitable commercially available wearable display, including but limited to Google Glass®, Epson Moverio®, or any other suitable device or binocular-style display. Alternatively, the display device 24 may be immobilized, handheld, or any other suitable display device compatible with the system 10. Software operable with the display device 24 automatically connects to the video feed being streamed by the receiver 12 and displays the video stream on the integrated display 26. The software may allow for basic video playback control via voice and touch commands handled by the display device 24.

In embodiments of the system 10 utilizing a wearable display device 24, the resulting image or video is preferably displayed within the field of view and/or task environment of the user, thereby eliminating the need for the user to obtain data relating to the task at hand by looking away from the task environment. For example, an operating surgeon can receive data pertaining to the patient, operation, and/or techniques being performed in real time without having to look away from the operating environment, thereby reducing the inherent risks associated with turning one's attention away from the task. It will be appreciated by one of ordinary skill in the art that the system and methods described herein can be utilized in conjunction with any task in which one wants or needs to share a video or image from a particular source, and are therefore not limited to a surgical environment or situation.

In one embodiment, and with reference to FIGS. 1A, 1B, and 2, software running on the display device 24 establishes a secure connection with the receiver 12. After a secure communication is established between the display device 24 and the receiver 12, the receiver 12 broadcasts raw byte data containing video frames to the display device 24. The display device 24 receives the byte information, decodes the signal, and plays it on the integrated display 26.

With reference now to FIG. 3 further detailing an embodiment of the receiver 12, processing an incoming video signal may include receiving a signal via a video input 32, wherein the receiver 12 accepts any analog or digital signal ranging from resolution 640×480 to 1920×1080 through a single DVI input, automatically detecting the signal type, and adjusting accordingly. The signal may also comprise any known signal type, including but not limited to a high resolution signal, 4 k, or three-dimensional video signal. The receiver 12 includes a transcoder 34 that transcodes the video signal into an H.264 encoded video feed at 1920×1080 at 30 frames per second. However, any suitable signal type may be utilized. The receiver 12 then hosts a streaming server that broadcasts, via a video transmitting unit 36, the transcoded stream for playback by any paired playback device or player 24. In one embodiment, a real time streaming protocol (RTSP) is utilized between the receiver 12 and the display device 24. In another embodiment, a secured socket connection is utilized between the receiver 12 and the display device 24. It will be appreciated that any other suitable secure transmission means may be utilized, which are therefore considered to be within the scope of the present disclosure.

With continued reference to FIG. 3, a networking unit 38 provides an integrated secured wireless network 22 and automatically assigns dedicated addresses to system components for convenient and configuration-free setup of all playback devices 24. In conjunction with the software operating on the player 24, the receiver 12 can simultaneously serve the video stream to over 200 pre-authorized devices 24 over the secured network 22. Alternatively, as described above, a secure socket connection is utilized.

With reference again to FIG. 1, one embodiment of the display device 24 is configured to automatically find and connect to the secured network hosted on the paired receiver 12. The display device 24 is loaded with software that then automatically connects to the stream hosted on the receiver 12 and plays the stream on the integrated display 26. In one embodiment, the stream is an RTSP stream, which provides a network control protocol for use in communications systems to control streaming media servers. Generally, users of media servers issue commands to facilitate real-time control of playback of media files from the server. Touch and voice controls are provided to control the basic playback including Play, Pause, and Stop/Disconnect. When the display device 24 comprises a wearable wireless device capable of control via voice controls, as illustrated in FIGS. 4A and 4B, the device can be worn and controlled keeping both hands free for tasks.

As illustrated herein, embodiments according to the teachings of the present disclosure provide signal transmission to a player 24 regardless of the source of the original signal, and thus are generic with regard to the type of video input.

Although the invention has been described relative to various selected embodiments herein presented by way of example, there are numerous variations and modifications that will be readily apparent to those skilled in the art in light of the above teachings. It is therefore to be understood that, within the scope of the claims hereto attached and supported by this specification, the invention may be practiced other than as specifically described.

That which is clamed is:

1. A video display system comprising:
an integrated wireless network secured using hardware restrictions preventing unauthorized connection;
a player having authorization to connect to the network;
a receiver having authorization to connect to the network, the receiver operable for accepting all analog or digital video signals through a single input, the receiver automatically transcoding the accepted video signal into a video stream for transmitting over an integrated secure network to the player; and
a wireless integrated display device having authorization to connect to the network operable with the receiver, wherein the player is configured to automatically find and connect to the secured network being paired with the receiver and connects to a real time streaming protocol stream hosted on the receiver for playing the stream on the integrated display.

2. A system for displaying a video, the system comprising:
a first device having a video signal input for receiving a video signal and a processing unit for processing the video signal, the processing unit providing video data corresponding to the video signal, the first device further comprising a network device for providing a secure wireless network; and
a display device having an integrated display and in communication with the secure wireless network, the display device having a receiver for receiving the video data from the first device via the secure wireless network, the display device further comprising an interpreting unit for interpreting the video data and providing an image corresponding to the video data, wherein the image is displayed on the integrated display.

3. The system of claim 2, wherein the video signal is at least one of an analog and a digital video signal.

4. The system of claim 3, wherein the first device processes the video signal by transcoding the video signal in real time.

5. The system of claim 4, wherein the display device interprets the video data by decoding the data.

6. The system of claim 5, wherein the display device automatically connects to the secure wireless network.

7. The system of claim 6, wherein the secure wireless network is secured using hardware restrictions.

8. The system of claim 7, wherein the display device is a wearable display device.

9. The system of claim 8, wherein the first device comprises a video input component, a video transcoding component, and a video transmitting component.

10. The system of claim 9, wherein the first device further comprises a networking component.

11. The system of claim 10, wherein the video signal includes data pertaining to a medical procedure.

12. The system of claim 11, wherein the first device includes an encoding unit that encodes the resulting data.

13. A method for displaying a video, the method comprising:
capturing a video signal with a receiver;
processing the video signal with the receiver to provide video data;
transmitting the video data to a display device;
interpreting the video data with the display device to provide an image; and
displaying the image on the display device.

14. The method of claim 13, wherein the processing the video signal further comprises transcoding the video signal.

15. The method of claim 14, wherein the processing the video signal further comprises encoding the video signal.

16. The method of claim 15, wherein the transmitting the video data occurs via a secure wireless network provided by the receiver.

17. The method of claim 16, wherein the interpreting the video data comprises decoding the video data with the display device.

18. The method of claim 17, wherein the decoding the video data with the display device comprises decoding the video data with a wearable display device.

19. The method of claim 13, wherein the displaying the image on the display device comprises displaying an image pertaining to a medical procedure.

20. The method of claim 19, wherein the displaying the image on the display device comprises assembling raw byte data into viewable video in near real-time.
